(19) United States
(12) Patent Application Publication
(10) Pub. No.: US 2020/0266654 A1
(43) Pub. Date: Aug. 20, 2020

(54) CHARGE CONTROLLER AND CHARGE CONTROLLING METHOD

(71) Applicant: DENSO TEN Limited, Kobe-shi (JP)

(72) Inventor: Katsutomo Sasakura, Kobe-shi (JP)

(73) Assignee: DENSO TEN Limited, Kobe-shi (JP)

(21) Appl. No.: 16/708,855

(22) Filed: Dec. 10, 2019

(30) Foreign Application Priority Data
Feb. 14, 2019 (JP) 2019-024738

(51) Int. Cl. H02J 7/34; H02J 7/00; B60L 50/64; B60L 53/62; B60L 58/18

(52) U.S. Cl. CPC H02J 7/342; H02J 7/0047; H02J 7/007; B60L 53/22; B60L 53/62; B60L 58/18; B60L 50/64

(57) ABSTRACT

A charge controller includes an estimation unit and a charge controlling unit. The estimation unit estimates a next charge to be performed on a high-voltage battery provided in a vehicle. The charge controlling unit executes, before the next charge of the high-voltage battery which is estimated by the estimation unit is started, charging from the high-voltage battery to a low-voltage battery provided in the vehicle.

### CROSS-REFERENCE TO RELATED APPLICATION

This application is based upon and claims the benefit of priority of the prior Japanese Patent Application No. 2019-024738, filed on Feb. 14, 2019, the entire contents of which are incorporated herein by reference.

### FIELD

The embodiment discussed herein is directed to a charge controller and a charge controlling method.

### BACKGROUND

Conventionally, for example, a vehicle such as an electric automobile is provided with (i) a high-voltage battery that supplies electric power to a drive source such as a motor and (ii) a low-voltage battery that supplies electric power to peripheral equipment such as a display and whose voltage is lower than that of the high-voltage battery (see, for example, Japanese Laid-open Patent Publication No. 2011-072080).

The low-voltage battery supplies electric power to peripheral equipment even during charge of the high-voltage battery. Thus, there presents, in some cases, a case in which a low-voltage battery is configured to be charged by a high-voltage battery during charge of the high-voltage battery, for example.

However, when the above-mentioned configuration is employed, there presents possibility that a charge time interval of the high-voltage battery is extended by a charge amount of the low-voltage battery. As described above, the above-mentioned conventional technology has room for improvement in shortening a charge time interval of the high-voltage battery.

### SUMMARY

A charge controller according to an embodiment includes an estimation unit and a charge controlling unit. The estimation unit estimates a next charge to be performed on a high-voltage battery provided in a vehicle. The charge controlling unit executes, before the next charge of the high-voltage battery which is estimated by the estimation unit is started, charging from the high-voltage battery to a low-voltage battery provided in the vehicle.

### BRIEF DESCRIPTION OF DRAWING(S)

A more complete appreciation of the invention and many of the attendant advantages thereof will be readily obtained as the same becomes better understood by reference to the following detailed description when considered in connection with the accompanying drawings, wherein:

FIG. 1 is a diagram illustrating the outline of a charge controlling method according to an embodiment;

FIG. 2 is a block diagram illustrating a configuration example of a charge system including a charge controller;

FIG. 3 is a block diagram illustrating a configuration example of the charge controller and the like; and

FIG. 4 is a flowchart illustrating a processing procedure to be executed by the charge controller.

### DESCRIPTION OF EMBODIMENTS

1. Outline of Charge Controlling Method

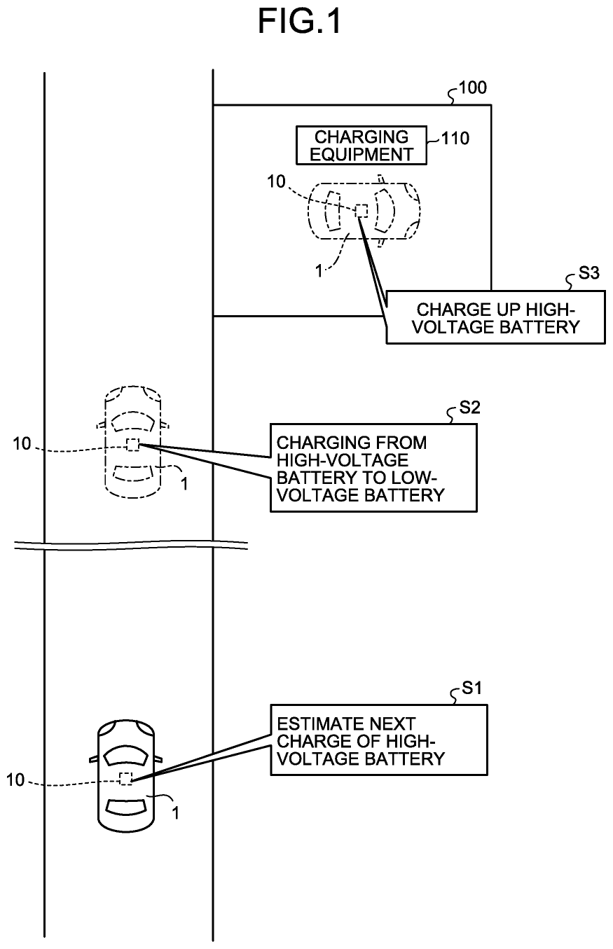

First, the outline of a charge controlling method according to the embodiment will be explained with reference to FIG. 1. FIG. 1 is a diagram illustrating the outline of the charge controlling method according to the embodiment.

The charge controlling method according to the embodiment is executed by a charge controller 10, for example. Specifically, as illustrated in FIG. 1, the charge controller 10 is provided in a vehicle 1. For example, the vehicle 1 is an electric automobile, a plug-in hybrid vehicle, or the like; however, not limited thereto. Moreover, the vehicle 1 is provided with a high-voltage battery and a low-voltage battery (not illustrated), and charging thereof is controlled by the charge controller 10.

The high-voltage battery of the vehicle 1 is charged up by a charging facility 100 included in a charging equipment 110, for example. The charging equipment 110 is capable of performing fast charge on the high-voltage battery; however, not limited thereto.

During charge of the above-mentioned high-voltage battery, the low-voltage battery is supplying electric power to peripheral equipment. Thus, for example, if the low-voltage battery is configured to be charged up by the high-voltage battery while charge of the high-voltage battery is being performed by the charging equipment 110, there presents possibility that a charge time interval of the high-voltage battery is extended by a charge amount of the low-voltage battery.

Thus, the charge controller 10 according to the present embodiment is configured to be capable of shortening a charge time interval of the high-voltage battery.

Specifically, the charge controller 10 estimates the next charge of the high-voltage battery (Step S1). For example, the charge controller 10 is capable of estimating the next charge of the high-voltage battery on the basis of the high-voltage battery remaining of the high-voltage battery and information on a charging facility located in the vicinity of the vehicle 1, this point will be mentioned later.

Assume that the charge controller 10 estimates that the next charge of the high-voltage battery will be performed in the charging facility 100 illustrated in FIG. 1. In this case, as indicated by the vehicle 1 of one-dot chain lines, the charge controller 10 performs, in advance, charging from the high-voltage battery to the low-voltage battery before the vehicle 1 arrives at the charging facility 100 (Step S2).

In other words, the charge controller 10 executes charging from the high-voltage battery to the low-voltage battery before the estimated next charge of the high-voltage battery is started. For example, the charge controller 10 causes the low-voltage battery to be fully charged by charging from the high-voltage battery before the next charge of the high-voltage battery is started.

As indicated by the vehicle 1 of two-dot chain lines, the charge controller 10 charges up the high-voltage battery when the vehicle 1 arrives at the charging facility 100 (Step S3). While the high-voltage battery is being charged up, the charge controller 10 shuts off an electric connection between the high-voltage battery and the low-voltage battery so as not to execute charging the low-voltage battery, this point will be mentioned later.

As described above, the charge controller 10 according to the present embodiment is configured to execute charging from the high-voltage battery to the low-voltage battery before the estimated next charge of the high-voltage battery is started. Thus, charging from the high-voltage battery to the low-voltage battery is not performed during charge of the high-voltage battery, so that it is possible to shorten a charge time interval of the high-voltage battery.

The low-voltage battery has been charged up before the high-voltage battery starts to be charged, and thus even when electric power is supplied to peripheral equipment during charge of the high-voltage battery, it is possible to prevent occurrence of a dead battery or the like.

2. Configuration of Charge System Including Charge Controller

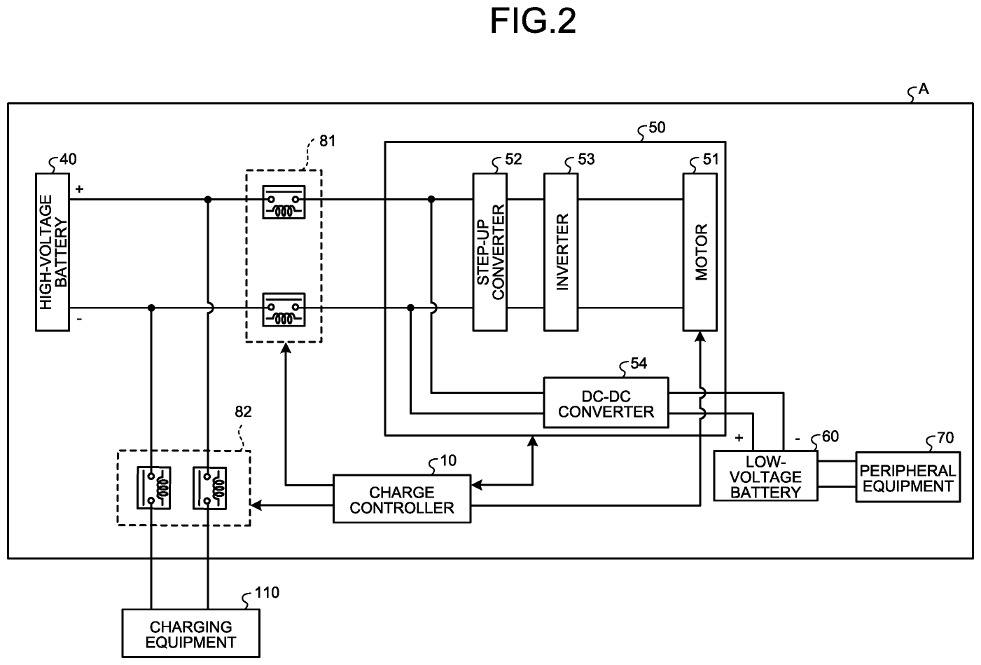

Next, a configuration of a charge system A including the charge controller 10 according to the embodiment will be explained with reference to FIG. 2. FIG. 2 is a block diagram illustrating a configuration example of the charge system A including the charge controller 10. Note that in the block diagram illustrated in FIG. 2, configuration elements needed for explaining features of the present embodiment are indicated by using functional blocks, and description of common configuration elements is omitted.

In other words, each component of each apparatus in the block diagram illustrated in FIG. 2 is functionally conceptual, and thus, does not always physically configured as illustrated in the drawings. For example, a specific mode of separation or integration of each apparatus is not limited to that illustrated in the drawings. That is, all or some of the components can be configured by separating or integrating them functionally or physically in any unit, according to various types of loads, the status of use, etc.

As illustrated in FIG. 2, the charge system A includes the above-mentioned charge controller 10, a high-voltage battery 40, a high-voltage device for travelling 50, a low-voltage battery 60, and peripheral equipment 70. The high-voltage device for travelling 50 includes a motor 51, a step-up converter 52, an inverter 53, and a DC-DC converter 54.

The high-voltage battery 40 supplies electric power to the motor 51, for example. A rated voltage of the high-voltage battery 40 is, for example, 200 V, and a rated voltage of the low-voltage battery 60 is, for example, 12 V. In other words, a rated voltage of the low-voltage battery 60 is lower than a rated voltage of the high-voltage battery 40.

A main relay 81 is arranged between the high-voltage battery 40 and the high-voltage device for travelling 50. When the main relay 81 is closed, electric power is supplied to the high-voltage device for travelling 50 from the high-voltage battery 40.

For example, the step-up converter 52 steps-up a voltage (for example, 200 V) of electric power, which is output from the high-voltage battery 40, to a rated voltage (for example, 500 V) of the motor 51, and outputs the stepped-up electric power to the inverter 53.

The inverter 53 converts the electric power stepped-up by the step-up converter 52 from direct current into alternate current, and supplies the converted alternate-current electric power to the motor 51. The motor 51 is driven by the alternate-current electric power converted by the inverter 53.

The DC-DC converter 54 steps-down a voltage (for example, 200 V) of electric power, which is output from the high-voltage battery 40, to a rated voltage (for example, 12 V) of the low-voltage battery 60, and outputs the stepped-down electric power to the low-voltage battery 60. Thus, the low-voltage battery 60 is charged up. Note that the low-voltage battery 60 is charged up only while the vehicle 1 is running; however, not limited thereto.

The low-voltage battery 60 supplies electric power to the peripheral equipment 70 and the like, for example. In other words, the low-voltage battery 60 is a battery for peripheral equipment.

The peripheral equipment 70 includes a display (not illustrated); however, may include, for example, a control ECU that operates during charge of the high-voltage battery 40.

The charging equipment 110, which is capable of charging up the high-voltage battery 40, is connectable to the high-voltage battery 40 and the main relay 81 therebetween via a charge relay 82, for example. Therefore, when the charge relay 82 is closed under a state where the charging equipment 110 is connected to the charge system A, electric power is supplied from the charging equipment 110 to the high-voltage battery 40 and the high-voltage battery 40 is charged up.

The charge controller 10 is capable of controlling operations of the above-mentioned main relay 81 and the above-mentioned charge relay 82. The charge controller 10 according to the present embodiment closes the charge relay 82, and opens the main relay 81 when the high-voltage battery 40 is being charged up by the charging equipment 110.

In other words, the charge controller 10 is configured to open, when the high-voltage battery 40 is being charged up, the main relay 81 so as to shut off an electric connection between the high-voltage battery 40 and the low-voltage battery 60.

Thus, charging from the high-voltage battery 40 to the low-voltage battery 60 is not executed during charge of the high-voltage battery 40, so that it is possible to further shorten a charge time interval of the high-voltage battery 40.

Moreover, the charge controller 10 opens, when the high-voltage battery 40 is being charged up, the main relay 81, and shuts off an electric connection between the high-voltage battery 40 and a device to which electric power is supplied from the high-voltage battery 40, in other words, the high-voltage device for travelling 50.

Thus, it is possible to further shorten a charge time interval of the high-voltage battery 40. In other words, for example, if the main relay 81 is closed when the high-voltage battery 40 is being charged up, needless electric-power consumption occurs due to inflow of current to the high-voltage device for travelling 50 and the like, thereby leading to extension of a charge time interval of the high-voltage battery 40 in some cases.

On the other hand, in the present embodiment, an electric connection between the high-voltage battery 40 and the high-voltage device for travelling 50 is shut off by opening the main relay 81 when the high-voltage battery 40 is being charged up, and thus the above-mentioned needless electric-power consumption hardly occurs, so that it is possible to further shorten a charge time interval of the high-voltage battery 40.

3. Configuration of Charge Controller

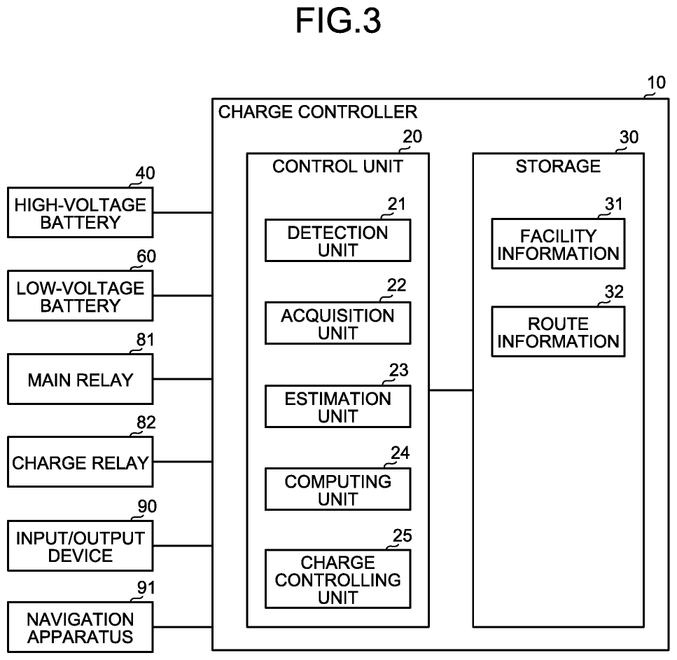

Next, a configuration of the charge controller 10 according to the embodiment and the like will be explained with reference to FIG. 3. FIG. 3 is a block diagram illustrating a configuration example of the charge controller 10 and the like.

As illustrated in FIG. 3, the charge controller 10 includes a control unit 20 and a storage 30. The charge controller 10 may be connected to, for example, an input/output device 90 and a navigation apparatus 91, in addition to the above-mentioned high-voltage battery 40, the low-voltage battery 60, the main relay 81, and the charge relay 82.

The input/output device 90 is a device capable of inputting/outputting various kinds of information to a user such as a driver of the vehicle 1. For example, the input/output device 90 is a device that outputs, to a user, guide information on a charging facility to be mentioned later, or to which selection information on a charging facility by a user is input. When the selection information on a charging facility is input from a user, the input/output device 90 outputs the selection information to the charge controller 10. For example, a display of a touch-panel type, a speaker and a microphone, or the like may be used as the input/output device 90; however, not limited thereto.

For example, when a user of the vehicle 1 sets a destination, the navigation apparatus 91 displays, on a display screen, route information indicating a travelling route of the vehicle 1 from the present location to the destination in such a manner that the route information is superposed on map information, so as to perform route guidance on the user. When there presents route information, the navigation apparatus 91 outputs the route information to the charge controller 10.

The control unit 20 of the charge controller 10 includes a detection unit 21, an acquisition unit 22, an estimation unit 23, a computing unit 24, and a charge controlling unit 25. The storage 30 stores therein facility information 31, route information 32, various programs, setting data, and the like. The charge controller 10 includes a computer that includes, for example, a Central Processing Unit (CPU), a Read Only Memory (ROM), a Random Access Memory (RAM), a Hard Disk Drive (HDD), an input/output port, and the like; and various circuits.

The CPU of the computer reads out and executes a program stored in the ROM, for example, so as to function as the detection unit 21, the acquisition unit 22, the estimation unit 23, the computing unit 24, and the charge controlling unit 25 of the control unit 20. All or a part of the detection unit 21, the acquisition unit 22, the estimation unit 23, the computing unit 24, and the charge controlling unit 25 may be constituted of hardware such as an Application Specific Integrated Circuit (ASIC) and a Field Programmable Gate Array (FPGA).

The storage 30 is constituted of a storage device such as a RAM and a HDD, and stores therein the above-mentioned facility information 31, the route information 32, and the like. The charge controller 10 may acquire the above-mentioned program and/or various kinds of information via another computer connected via a wired or wireless network or a portable recording medium.

The facility information 31 is information on a charging facility (for example, charging station for vehicle) that is capable of charging up the high-voltage battery 40. For example, the facility information 31 includes various kinds of information on a charging facility such as position information on the charging facility and charge-rate information. The facility information 31 may be previously stored in the storage 30, or may be acquired from an external server (not illustrated). The route information 32 is route information that is output from the above-mentioned navigation apparatus 91.

The detection unit 21 is capable of detecting high-voltage battery remaining of the high-voltage battery 40 and low-voltage battery remaining of the low-voltage battery 60. The detection unit 21 outputs, to the estimation unit 23, information that indicates the high-voltage battery remaining, and outputs, to the computing unit 24, information indicating the low-voltage battery remaining.

The acquisition unit 22 reads out and acquires the facility information 31 and/or the route information 32 stored in the storage 30, and outputs, to the estimation unit 23, the acquired facility information 31 and the acquired route information 32.

The estimation unit 23 estimates the next charge of the high-voltage battery 40. For example, the estimation unit 23 searches for a charging facility to be arrived at before the high-voltage battery remaining runs short, on the basis of high-voltage battery remaining detected by the detection unit 21 and the facility information 31 and/or the route information 32 acquired by the acquisition unit 22. The number of charging facilities searched by the estimation unit 23 may be one or more.

The estimation unit 23 outputs, to the input/output device 90, guide information that suggests charging at the searched charging facility so as to suggest that a user performs charging on the high-voltage battery 40. For example, when a user operates the input/output device 90 to select a charging facility, selection information indicating the selected charging facility is input to the estimation unit 23 from the input/output device 90.

When there presents a plurality of charging facilities searched by the estimation unit 23, guide information including the plurality of charging facilities is output to the input/output device 90, and a charging facility desired by the user is selected from among the plurality of charging facilities. The estimation unit 23 may include, in the guide information, charge-rate information and the like to be able to make a comparison between the charge-rates. The estimation unit 23 may output, to the input/output device 90, only a charging facility whose charge rate is the most inexpensive of the plurality of charging facilities, for example.

Thus, it is estimated by the estimation unit 23 that the next charge of the high-voltage battery 40 is to be performed at the charging facility selected by the user. In the above-description, the next charge of the high-voltage battery 40 is estimated by a user's selection; however, not limited thereto. For example, a use history of a charging facility of a user and the like may be stored in the storage 30 as the facility information 31, the estimation unit 23 may estimate, on the basis of the facility information 31, that the user will use a charging facility whose use history is comparatively many, and further estimates that the next charge of the high-voltage battery 40 will be performed at the estimated charging facility, namely, estimation may be executed by another method.

As described above, on the basis of the high-voltage battery remaining, the facility information 31, and the route information 32, the estimation unit 23 estimates a charging facility at which the next charge of the high-voltage battery 40 is to be performed, and further estimates a distance to the estimated charging facility and a time interval until arriving at the charging facility.

Thus, according to the present embodiment, a distance and a time interval until the next charge of the high-voltage battery 40 is started may be precisely estimated. The estimation unit 23 does not necessarily estimate both of a distance to a charging facility and a time interval until arriving at the charging facility, and may estimate one of them.

The computing unit 24 computes a full-charge time interval until the low-voltage battery 60 has been fully charged up, on the basis of the low-voltage battery remaining detected by the detection unit 21 and a distance and/or a time interval until arriving at the estimated charging facility. For example, the computing unit 24 computes a full-charge time interval in a case where the high-voltage battery 40 charges up the low-voltage battery 60 having the detected low-voltage battery remaining, during a time interval until arriving at the estimated charging facility (namely, before arriving at charging facility).

The charge controlling unit 25 executes charging from the high-voltage battery 40 to the low-voltage battery 60 before the next charge of the high-voltage battery 40 is started. For example, the charge controlling unit 25 compares the time interval until arriving at the charging facility with the full-charge time interval, and starts charging from the high-voltage battery 40 to the low-voltage battery 60 while the full-charge time interval is shorter than the time interval until arriving at the charging facility.

As described above, the charge controlling unit 25 uses a full-charge time interval, so that it is possible to reliably complete charging from the high-voltage battery 40 to the low-voltage battery 60 before the next charge of the high-voltage battery 40 is started.

When the vehicle 1 has arrived at the charging facility, the charge controlling unit 25 starts to charge up the high-voltage battery 40. Specifically, when the charge system A (see, FIG. 2) of the vehicle 1 is connected to the charging equipment 110 (see, FIG. 2) the charging facility, the charge controlling unit 25 closes the charge relay 82 (see, FIG. 2), and starts to charge up (for example, fast charge) the high-voltage battery 40.

In this case, charging of the low-voltage battery 60 has been already completed (fully charged), and thus the charge controlling unit 25 opens the main relay 81 (see, FIG. 2) so as to shut off an electric connection between the high-voltage battery 40 and the low-voltage battery 60. Therefore, during charge of the high-voltage battery 40, charging is not performed from the high-voltage battery 40 to the low-voltage battery 60, so that it is possible to shorten a charge time interval of the high-voltage battery 40.

When the high-voltage battery 40 is being charged, the charge controlling unit 25 opens the main relay 81 (see, FIG. 2) so as to shut off an electric connection between the high-voltage battery 40 and a device (namely, the high-voltage device for travelling 50) to which electric power is supplied from the high-voltage battery 40. Thus, as described above, it is possible to further shorten a charge time interval of the high-voltage battery 40.

In the present embodiment, the vehicle 1 may be a manual-drive vehicle requiring driving operations of a driver, or may be an autonomous-drive vehicle capable of autonomous driving and not requiring a part or all of driving operations of a driver. When the vehicle 1 according to the present embodiment is an autonomous-drive vehicle, the vehicle 1 may travel by autonomous driving to a charging facility at which the next charge of the high-voltage battery 40, which is estimated by the estimation unit 23, will be performed.

Thus, the vehicle 1 reliably arrives at a charging facility that is selected by a user, so that it is possible to reliably perform charging of the high-voltage battery 40.

Moreover, for example, there presents a case where the high-voltage battery 40 is charged up at a charging facility far from a route (namely, charging facility positioned far from planned travelling route) planned by a user. In this case, even in a case where a charge time interval of the high-voltage battery 40 is shortened, when a time interval until travelling to the charging facility is longer than the shortened time interval, the shortening of the time interval loses its meaning.

Thus, the charge controller 10 according to the present embodiment may compare the shortened time interval with the time interval until travelling to the charging facility, and may further estimate the next charge of the high-voltage battery on the basis of the comparison result.

Specifically, the computing unit 24 computes, on the basis of the high-voltage battery remaining, a first charge time interval in a case where charge is performed from the high-voltage battery 40 to the low-voltage battery 60 during charge of the high-voltage battery 40 and a second charge time interval in a case where charge is not performed from the high-voltage battery 40 to the low-voltage battery 60 during charge of the high-voltage battery 40. The above-mentioned first charge time interval is a charge time interval of the high-voltage battery 40 in which charge is being performed from the high-voltage battery 40 to the low-voltage battery 60 while the main relay 81 is closed during charge of the high-voltage battery 40. The second charge time interval is a charge time interval of the high-voltage battery 40 in which the main relay 81 is opened and charge is not performed from the high-voltage battery 40 to the low-voltage battery 60 during charge of the high-voltage battery 40. Note that the low-voltage battery 60 is not charged up during the second charge time interval, and thus the second charge time interval is shorter than the first charge time interval.

The computing unit 24 computes a charge-time difference, namely, a shortened time interval, which indicates a difference between the first charge time interval and the second charge time interval. Moreover, the computing unit 24 computes a time interval for dropping-by, which is needed for dropping by a facility that is capable of charging up the high-voltage battery 40, in other words, a time interval until arriving at the charging facility.

The estimation unit 23 compares the charge-time difference with the time interval for dropping-by to be able to estimate the next charge of the high-voltage battery 40 on the basis of the comparison result. In other words, when the charge-time difference is shorter than the time interval for dropping-by, the estimation unit 23 does not estimate that the next charge will be performed at a charging facility for which the time interval for dropping-by is obtained, because the shortened time interval is meaningless.

On the other hand, when the charge-time difference is longer than the time interval for dropping-by, the estimation unit 23 is able to estimate that the next charge will be performed at a charging facility for which the time interval for dropping-by is obtained. As described above, in the present embodiment, a shortened time interval and a time interval until arriving at a charging facility are compared with each other to estimate the next charge, so that a user is able to feel effects of shortening of a charge time interval of the high-voltage battery 40.

3. Charge Controlling Process of Charge Controller According to Embodiment

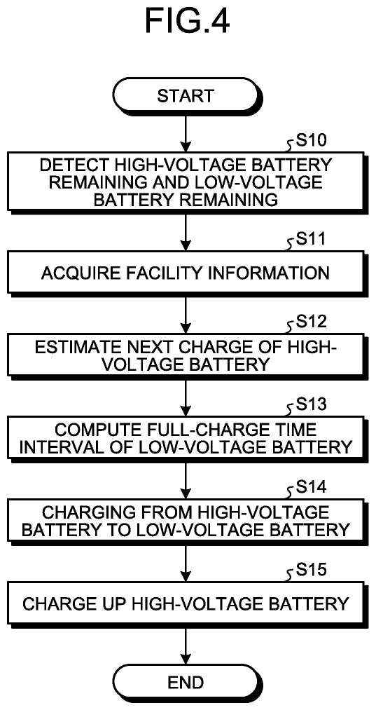

Next, details of a processing procedure of the charge controller 10 will be explained with reference to FIG. 4. FIG. 4 is a flowchart illustrating a processing procedure to be executed by the charge controller 10.

As illustrated in FIG. 4, the control unit 20 of the charge controller 10 detects the high-voltage battery remaining and the low-voltage battery remaining (Step S10). Next, the control unit 20 acquires the facility information 31 and the like (Step S11).

Next, the control unit 20 estimates the next charge of the high-voltage battery 40 on the basis of the high-voltage battery remaining and/or the facility information 31 (Step S12). Next, the control unit 20 computes, on the basis of the low-voltage battery remaining and the like, a full-charge time interval until the low-voltage battery 60 has been fully charged up (Step S13).

Next, before the estimated next charge of the high-voltage battery 40 is started, the control unit 20 executes, on the basis of the full-charge time interval and the like, charging from the high-voltage battery 40 to the low-voltage battery 60 (Step S14). When the vehicle 1 has arrived at the charging facility, the control unit 20 causes the high-voltage battery 40 to be charged up (Step S15).

As described above, the charge controller 10 according to the embodiment includes the estimation unit 23 and the charge controlling unit 25. The estimation unit 23 estimates a next charge to be performed on the high-voltage battery 40 provided in the vehicle 1. The charge controlling unit 25 executes, before the next charge of the high-voltage battery 40 which is estimated by the estimation unit 23 is started, charging from the high-voltage battery 40 to the low-voltage battery 60 provided in the vehicle 1. Thus, it is possible to shorten a charge time interval of the high-voltage battery.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

1. A charge controller comprising:
an estimation unit that estimates a next charge to be performed on a high-voltage battery provided in a vehicle; and
a charge controlling unit that executes during operation of the vehicle, based on an estimated start of the next charge of the high-voltage battery which is estimated by the estimation unit, charging from the high-voltage battery to a low-voltage battery provided in the vehicle before the estimated start.

2. The charge controller according to claim 1 further comprising:
a detection unit that detects a voltage level of the high-voltage battery; and
an acquisition unit that acquires facility information on a facility capable of charging the high-voltage battery, wherein
the estimation unit estimates, based on the voltage level detected by the detection unit and the facility information acquired by the acquisition unit, at least one of (i) a distance to the facility and (ii) a time interval until arriving at the facility.

3. The charge controller according to claim 2, wherein
the vehicle includes a vehicle capable of autonomous driving, and travels, by autonomous driving, to the facility.

4. The charge controller according to claim 1 further comprising:
a computing unit that computes a full-charge time interval until the low-voltage battery has been fully charged, wherein
the charge controlling unit completes, based on the full-charge time interval computed by the computing unit, charging from the high-voltage battery to the low-voltage battery before the next charge of the high-voltage battery is started.

5. A charge controller comprising:
an estimation unit that estimates a next charge to be performed on a high-voltage battery provided in a vehicle;
a charge controlling unit that executes, before the next charge of the high-voltage battery which is estimated by the estimation unit is started, charging from the high-voltage battery to a low-voltage battery provided in the vehicle; and
a computing unit configured to:
compute a charge-time difference indicating a difference between (i) a first charge time interval in a case where charge is performed from the high-voltage battery to the low-voltage battery in charging up the high-voltage battery and (ii) a second charge time interval in a case where the charge is not performed from the high-voltage battery to the low-voltage battery; and
compute a time interval for dropping-by that is needed for dropping by a facility capable of charging up the high-voltage battery, wherein
the estimation unit is further configured to:
compare the charge-time difference and the time interval for dropping-by, which are computed by the computing unit, with each other; and
estimate a next charge of the high-voltage battery based on a comparison result.

6. The charge controller according to claim 1, wherein
when the high-voltage battery is being charged at a charging facility, the charge controlling unit shuts off an electric connection between the high-voltage battery and the low-voltage battery.

7. The charge controller according to claim 1, wherein
when the high-voltage battery is being charged at a charging facility, the charge controlling unit shuts off an electric connection between the high-voltage battery and a device to which electric power is supplied from the high-voltage battery.

8. A charge controlling method comprising:
estimating a next charge to be performed on a high-voltage battery provided in a vehicle; and
executing during operation of the vehicle, based on an estimated start of the next charge of the high-voltage battery which is estimated in the estimating, charging from the high-voltage battery to a low-voltage battery provided in the vehicle before the estimated start.

9. The charge controller according to claim 1, wherein the estimation unit and the charge controlling unit are located in the vehicle.

10. The charge controller according to claim 1, wherein the next charge is at a charging facility separate from the vehicle.

11. The charge controller according to claim 1, wherein the high-voltage battery supplies electric power to a high-voltage device of the vehicle and the low-voltage battery supplies electric power to a low-voltage device of the vehicle.

12. The charge controller according to claim 2, wherein the detection unit and the acquisition unit are located in the vehicle.

13. The charge controller according to claim 4, wherein the computing unit is located in the vehicle.
